(19) United States
(12) Patent Application Publication
(10) Pub. No.: US 2008/0240851 A1
(43) Pub. Date: Oct. 2, 2008

(54) Device for Fastening an Attachment to a Support Part

(75) Inventor: Uwe Spitz, Rheinfelden (DE)

Correspondence Address: BAKER & DANIELS LLP;111 E. WAYNE STREET, SUITE 800, FORT WAYNE, IN, 46802, US

(73) Assignee: A. Raymond et Cie, Grenoble (FR)

(21) Appl. No.: 12/090,287

(22) PCT Filed: Oct. 18, 2006
(86) PCT No.: PCT/EP06/10025

§ 371 Date: Apr. 15, 2008

(30) Foreign Application Priority Data
Oct. 28, 2005 (DE) 10 2005 051 678.5

(51) Int. Cl. F16B 5/06; B60N 3/02

(52) U.S. Cl. 403/374.2; 403/338; 403/373

(57) ABSTRACT

A device for fastening an attachment to a support part has a clamp (1) which has a base plate (2) and two leg arrangements arranged on opposite sides of the base plate (2) and having inner legs (5, 6) and outer legs (9, 10). Furthermore, there is an engagement unit having a bearing piece (14) that can be connected to the attachment and having a locking part (26) displaceably mounted in the bearing piece (14). The locking part (26) has at least two locking feet (29) and is arranged free of effective engagement relative to the clamp (1) in a release position and is in engagement with the clamp (1) in a locking position with the locking feet (29) in such a way that at least one respective locking foot (29) blocks a movement of an outer leg (9, 10) in the direction of the inner leg (5, 6) connected to it. As a result, very reliable manipulation and high pull-out strength are achieved.

### RELATED APPLICATION

This application is a U.S. National Phase Patent Application based on International Application Serial No. PCT/US2006/010025 filed Oct. 18, 2006, the disclosure of which is hereby explicitly incorporated by reference herein.

### BACKGROUND OF THE INVENTION

1. Field of the Invention

The invention relates to a device for fastening an attachment to a support part.

2. Description of the Related Art

One device for fastening an attachment to a support part is known from EP 0 743 461 A1. The known device for fastening an attachment to a support part has a clamp, which has a base plate and two leg arrangements arranged on opposite sides of the base plate. Each leg arrangement has an inner leg and an outer leg placed on the base plate, each outer leg being connected with the inner leg assigned to it by a bent curved segment and with a free end opposite the curved segment extending to the area of the base plate. Furthermore, there is an engagement unit which can be brought into engagement with the clamp and the attachment. The engagement unit has a bearing piece that can be connected with the attachment and a locking part displaceably mounted in the bearing piece, the locking part being arranged free of effective engagement to the clamp in a release position and in a locking position with the locking feet in engagement with the clamp in such a way that at least one locking part blocks any movement of the outer leg in the direction of the inner leg connected with that outer leg. In this device, the bearing piece is formed as a massive block, which in the locking position is arranged completely filling the space between the inner legs in the bearing piece.

From DE 43 09 024 A1, a fastening element for parts to be fastened to automobile body parts such as armrests, support grips, sunshades, rear-view mirrors and the like is known, in which the securing arrangement has a rotatable hinged lid on which a securing tab is integrally molded, which holds a locking part in a locking position in the closed position of the hinged lid.

From DE 35 24 651 A1, a device is known for fastening an attachment to a support part which has a clamp which is positioned in a opening in the support part and which is designed with a base plate and two leg arrangements arranged on opposite sides of the base plate. Each leg arrangement has an inner leg and an outer leg placed on the base plate, the outer leg being connected with the inner leg by a bent segment and with a free end opposite the bent segment extending to the area of the base plate. Furthermore, there is an engagement unit in the form of a screw, which can be brought into engagement with the clamp and the attachment. The screw reaches through an opening in the attachment and comes into engagement with a threaded area fashioned in the base plate, while bent segments of the free ends of the outer legs are supported on the back side of the support part opposite the attachment. When the screw is tightened, with correct arrangement of the base plate and the outer legs, the outer legs generally spread outward and thus raise the pull-out strength of the device of this type. However, there is the risk that in case of improper arrangement of the clamp, the outer legs may enter the opening of the support part and the intended pull-out strength may not be achieved. There are similar problems if the clamp is tipped.

### SUMMARY OF THE INVENTION

The present invention provides a device for fastening an attachment to a support part which, while having a compact design of the locking part taking up little space, is characterized by high pull-out strength.

Since, in the device according to the invention, the movement of the outer legs is blocked by the action of at least one locking foot assigned to a leg arrangement of the locking part, with a design of the locking part that takes up little space, the movement of the outer legs in the direction of the inner legs assigned to them is blocked.

In one form thereof, the present invention provides a device for fastening an attachment to a support part with a clamp, which has a base plate and two leg arrangements arranged on opposite sides of the base plate, each leg arrangement having an inner leg and an outer leg placed on the base plate, each outer leg being connected by means of a bent curved segment with the inner leg assigned to it and with a free end opposite the curved segment extending to the area of the base plate, and with an engagement unit that is able to be brought into engagement with the clamp and the attachment, the engagement unit having a bearing piece that can be connected with the attachment and a locking part displaceably mounted in the bearing piece, the locking part in a release position being arranged free of effective engagement with the clamp and in a locking position with the locking feet in engagement with the clamp in such a way that at least one locking foot blocks any movement of an outer leg in the direction of the inner leg connected with the respective outer leg, characterized in that the locking part has at least two locking feet, that in the locking position each locking foot is inside a free space formed between a free end of the leg finger facing away from the outer leg and the base plate and with its exterior adjacent to the free end of the leg finger and that each outer leg has on its free end at least one bent leg finger in the direction of the inner leg connected with it, which in the locking position of the locking part lies adjacent to a locking foot.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective exploded view of an exemplary embodiment of a device according to the invention with a clamp, a bearing piece and a locking part;

FIG. 2 is a cross section of the exemplary embodiment according to FIG. 1 with a hinged lid to the bearing piece in the open position; and

FIG. 3 is a cross section of the exemplary embodiment according to FIG. 1 with the hinged lid in the closed position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

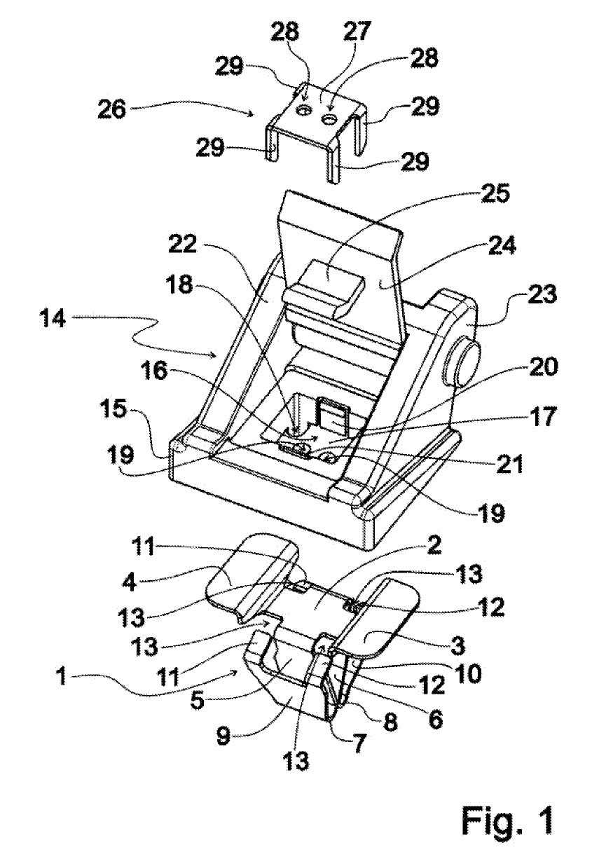

FIG. 1 shows, in a perspective view, an exemplary embodiment of a device according to the invention, which serves in particular to fasten a roof grip for a motor vehicle. The exemplary embodiment according to FIG. 1 has a clamp 1 made of metal which is designed with a base plate 2 and two wing-like edge sections 3, 4 integrally molded to the base plate 2. Furthermore, inner legs 5, 6 are integrally molded to each side between the edge sections 3, 4 on the base plate 2, which extend from the base plate 2 in a direction pointing to one another. On the ends of the inner legs 5, 6 opposite the base plate 2 there are curved segments 7, 8 bent in an approximately semicircular shape, on which outer legs 9, 10 are placed, extending in the direction of the base plate 2.

The outer legs 9, 10 are arranged approximately parallel to the inner legs 5, 6 and each have two leg fingers 11, 12 arranged at the edges on their free ends facing the base plate 2 which are arranged at approximately right angles to the respective outer legs 9, 10 and extend in the direction of the inner legs 5, 6 directly opposite them. The leg fingers 11, 12 of an outer leg 9, 10 have a distance from one another at least as great as the width of the arranged inner leg 5, 6 in the projection area on the base plate 2. Free spaces 13 are arranged between the free ends of the leg fingers 11, 12 facing away from the outer legs 9, 10 and the base plate 2.

Furthermore, the exemplary embodiment according to FIG. 1 has a bearing piece 14 made of a plastic material in which, when properly arranged as intended, the edge sections 3, 4 of the clamp 1 are embedded, for example by extrusion. The bearing piece 14 has in this exemplary embodiment a foundation plate 15 with an approximately square cross section, in which a receiving space 16 is centrally formed. The receiving space 16 is closed off with a bottom plate 17 on the side facing the clamp 1, the bottom plate 17 having foot openings 18 in its corner areas, which create a passage to the clamp 1. Furthermore, round through-holes 19 are formed in the central area of the bottom plate 17.

On opposite sides of the receiving space facing one another, there are elastic retaining tabs 20, 21 formed with end projections which extend away from the bottom plate 17 to the edge of the receiving space 16 opposite the bottom plate 17.

On the edge sides of the foundation plate 15, side plates 22, 23 are integrally molded, which are approximately triangular and on whose convex side a pivoting hinged lid 24 is fitted. The hinged lid 24 has a securing tab 25 that is approximately centrally arranged and angled in an end area which, when the hinged lid 24 is conveyed from an open position shown in FIG. 1 to a closed position following the outside contour of the side plates 22, 23, reaches into the receiving area 16.

Finally it can be seen from FIG. 1 that the exemplary embodiment shown of the device according to the invention has an essentially square locking part 26 made of metal, which is formed with a mounting plate 27 in whose central area engagement holes 28 are formed as tool extension means arranged in a distance conforming to that of the through-holes 19. In the corner areas of the mounting plate 27, locking feet 29 are formed, extending perpendicular to the mounting plate 27 in a direction away from the mounting plate 27, which are present in an arrangement conforming to the distances of the foot openings 18 from one another. The dimensions of the mounting plate 27 are designed so that when the locking part 26 is inserted in the receiving space 16, the end projections of the retaining tabs 20 engage at the rear with the mounting plate 27.

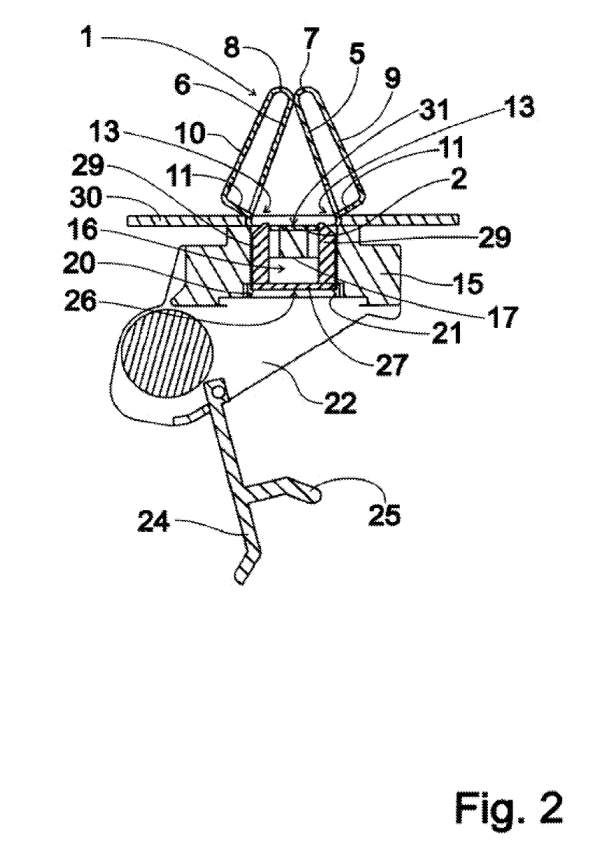

FIG. 2 shows the exemplary embodiment according to FIG. 1 in a cross section with the hinged lid 24 in an open position and the locking part 26 in an arrangement inserted in the receiving area 16 in a release position, in which the locking feet 29 having otherwise slanted end sides at best insignificantly project beyond the side of the foundation plate 15 facing the clamp 1. In this arrangement, the device according to the invention can be inserted in an attachment opening 31 incorporated in an attachment 30 with dimensions adapted to the clamp 1, the legs 9, 10 deflecting during the insertion process and after completion of the insertion process being in the relaxed position shown in FIG. 2. In this arrangement, the locking part 26 is held in a captive manner by the rear engagement of the projections formed on the retaining tabs 20, 21.

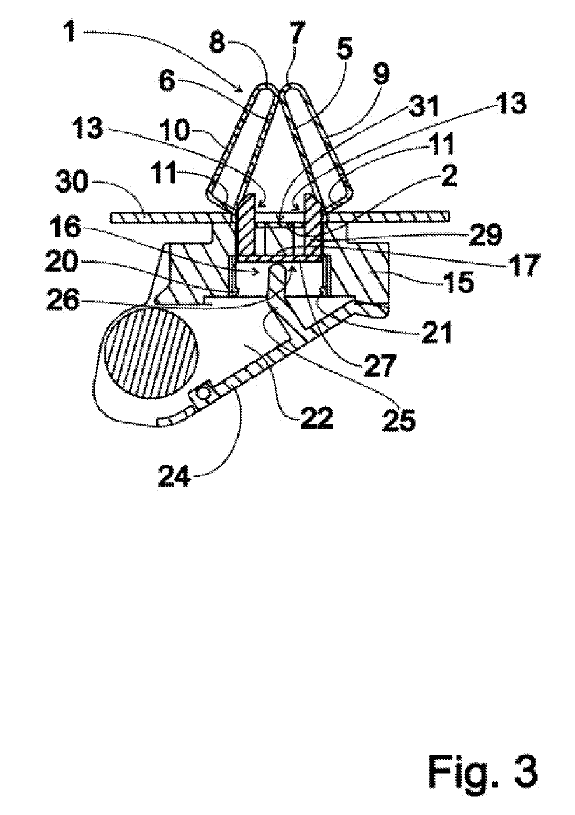

FIG. 3 shows a cross section of the exemplary embodiment according to FIG. 1 with a locking part 26 inserted up to the stop on the bottom plate 17 in the receiving space 16 and the hinged lid 24 in a completely closed position, in which the free end of the correspondingly dimensioned securing tab 25 is arranged near the mounting plate 27 of the locking part 26. It can be seen from FIG. 3 that in this locking position of the locking parts 26, the locking feet 29 have now entered the free spaces 13 and lie with their exteriors adjacent to the free ends of the leg fingers 11, 12. The locking feet 29 preferably press the outer legs 9, 10 somewhat outward and away from the corresponding inner legs 5, 6. As a result, the movement of the outer legs 9, 10 in the direction of the inner legs 5, 6 is blocked so that a high pull-out strength is ensured, particularly also in case of the effect of tipping moments on the bearing piece 14.

To remove the device according to the invention according to the described exemplary embodiment, after the opening of the hinged lid 24, the ends of a pair of round pliers, for example, are inserted in the through-holes 19 aligned with the engagement holes 28 but of larger dimensions. After appropriate manipulation of the round pliers, the locking part 26 is pulled out of the engagement of the locking feet 29 into the free spaces 13, so that the device can again be removed from the attachment 30. In this way, the fastening and loosening process can essentially be repeated as often as desired.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-6. (canceled)

7. A device for fastening an attachment to a support part, comprising:
a clamp having a base plate and two leg arrangements disposed on opposite sides of said base plate, each leg arrangement including an inner leg and an outer leg, each outer leg connected to a respective inner leg by a bent curved segment and including a free end opposite said curved segment having at least one leg finger extending to a location proximate said base plate;
an engagement unit engageable with said clamp and with the attachment, said engagement unit including a bearing piece connectable with the attachment; and
a locking part having at least two locking feet, said locking part displaceably receivable in said bearing piece between a release position and a locking position, said locking part in said release position being free of engagement with said clamp and, in said locking position, each said locking foot in engagement with said clamp and disposed within a free space formed between said base plate and a leg finger of said outer leg, with an exterior of said locking foot disposed adjacent a free end of said leg finger and blocking movement of said outer leg in a direction of said inner leg.

8. The device of claim 7 wherein, in said locking position, said locking part engaging said outer legs and pressing said free ends of said outer legs outwardly beyond a position of said outer legs in said release position.

9. The device of claim 7, wherein said bearing piece includes a receiving space and retaining elements that hold said locking part securely in said receiving space.

10. The device of claim 7, wherein said engagement unit includes a securing arrangement which, in said locking position, secures said locking part against unintentional displacement in said release position.

11. The device of claim 10, wherein said securing arrangement includes a rotatable hinged lid having a securing tab molded thereon which, in a closed position of said hinged lid, holds said locking part in said locking position.

12. The device of claim 7, wherein said locking part includes tool extension means engageable with a tool to move said locking part from said locking position to said release position.
